(19) United States
(12) Patent Application Publication
(10) Pub. No.: US 2009/0157460 A1
(43) Pub. Date: Jun. 18, 2009

(54) SYSTEM AND METHOD FOR PROVIDING PRODUCT AND SERVICE DATA

(76) Inventor: Karthikeyan Narayanaswamy, West Bloomfield, MI (US)

Correspondence Address: BROOKS KUSHMAN P.C., 1000 TOWN CENTER, TWENTY-SECOND FLOOR, SOUTHFIELD, MI, 48075, US

(21) Appl. No.: 11/954,759

(22) Filed: Dec. 12, 2007

(51) Int. Cl. G06Q 99/00

(52) U.S. Cl. 705/8; 705/1

(57) ABSTRACT

Product/service data may be provided to consumers in an environment of manufacturers/service providers, distributors and consumers linked via a data broker. The data broker may provide product/service data in response to receiving identifiers associated with products/services. The identifiers may be generated by the data broker. The identifiers may be provided to the consumers.

### BACKGROUND

1. Field of the Invention

The invention relates to systems and methods for providing product and service data.

2. Background Art

Data may assembled and distributed to users via various systems and methods. U.S. Pat. No. 6,377,956 to Hsu et al. is an example of such a system. According to Hsu et al., a system for automatically assembling product manuals based on a product model, a delivery model and a formal configuration specification includes a structure instantiator for instantiating a product manual structure from a model-specific configuration specification to create a logical structure for a product manual. The product manual structure incorporates product information from a product model. The product manual structure includes document objects. A manual configurer is included for configuring the product manual by binding the document objects in the logical structure to proper versions of component documents stored in a document database. A manual generator is also included for generating the product manual by physically extracting the document objects from the document database to a directory.

U.S. Pat. Pub. 2002/0091706 to Anderson et al. is another example of such a system. According to Anderson et al., a vehicle history and personalization system includes a communications network. The vehicle history and personalization system also includes a server computer in communication with the communications network and a client computer in communication with the communications network. The vehicle history and personalization system further includes a vehicle history database accessible by the server computer. The vehicle history database includes information for an individual vehicle relating to the design and manufacturing history of the individual vehicle. The vehicle history and personalization system also includes a program running on the server computer. The program is configured to provide access to the vehicle specific data stored in the vehicle history database based on a vehicle's specific identifier provided to the server computer by the client computer.

U.S. Pat. Pub. 2004/0098273 to Mayes is yet another example of such a system. According to Mayes, a customization apparatus includes a computer system for tracking objects to be assembled by separate identifying characters as the separately identified objects are assembled. The computer system includes a database containing object data. An assembly system for assembling the separately identified objects is connected to the computer system as is a printer system. The printer system produces customized information materials specific to each separately identified object as each separately identified object is assembled.

U.S. Pat. Pub. 2004/0220815 to Belanger et al. is an example of such a method. According to Belanger et al., an electronic document is generated in an automatic manner from a component part repository. Information blocks in the component part repository, such as information relating to a particular part in an engineering design, are stored instances of a common data model. The electronic document can be generated from the information blocks using scripting programs and document definition files designed to define the layout of the electronic manual. The tools used to create the electronic manual are re-useable and adaptable, allowing new documents for new customers to be efficiently created. A document may be distributed electronically over a network to the customer once created.

### SUMMARY

A method for providing information for an instance of a product or service via an information broker includes receiving identity information for a plurality of providers of products or services, generating a set of identifiers for instances of the products or services and mapping each set of the generated identifiers with the identity information for a respective one of the plurality of provides. The method also includes receiving an identifier associated with an instance of a product or service, determining whether the received identifier matches any of the generated identifiers and identifying one of the plurality of providers via the mapping if the received identifier matches any of the generated identifiers. The method further includes sending the received identifier to the one provider, receiving a first set of information identifying attributes of the instance of the product or service mapped with the received identifier, compiling a second set of information identifying attributes of the instance of the product or service based on the first set of information and providing the second set of information.

A method for providing information for an instance of a product or service via an information broker includes generating, for each of a plurality of providers of products or services, a respective set of identifiers for instances of products or services, sending a respective one of the sets of generated identifiers to each of the plurality of providers and receiving a mapping from one or more of the plurality of providers. Each mapping includes at least some of the generated identifiers each associated with a set of information identifying attributes of an instance of a product or service. The method also includes receiving a request for information about an instance of a product or service including an identifier associated with the instance of the product or service, determining whether the received identifier matches any of the generated identifiers and retrieving the set of information identifying attributes of the instance of the product or service requested via the mappings if the received identifier matches any of the generated identifiers. The method further includes compiling an additional set of information identifying attributes of the instance of the product or service requested based on the retrieved set of information and providing the additional set of information.

A computer system for generating a custom product manual includes a product manual module configured to receive optional product manual segments corresponding to optional product features and data indicative of optional product features of an instance of a product, a generating module configured to automatically generate a custom product manual based on the data indicative of the optional product features of the instance of the product and an interface module configured to output the custom product manual having at least one optional product manual segment corresponding to at least one optional product feature of the instance of the product.

A method for registering a product having a product code with the product manufacturer includes receiving customer information identifying a customer, receiving the product code from the customer and mapping the product code with the customer information. The method also includes identifying the manufacturer of the product based on the product code, prompting the customer to register the product with the manufacturer in response to receiving the product code from the customer and receiving a response to the prompt. The method further includes retrieving the customer information based on the product code and sending the customer information to the manufacturer.

While exemplary embodiments in accordance with the invention are illustrated and disclosed, such disclosure should not be construed to limit the claims. It is anticipated that various modifications and alternative designs may be made without departing from the scope of the invention.

### BRIEF DESCRIPTION OF THE DRAWINGS

FIG. 1 is a block diagram illustrating exemplary data flow between parties via a data broker.

FIG. 2 is a block diagram illustrating exemplary data flow between the manufacturer and broker of FIG. 1.

FIG. 3 is a flow chart of an exemplary method for transforming data into a standardized format.

FIG. 4 is a flow chart of an exemplary method for transforming options data into a type code format.

FIG. 5 is a block diagram illustrating an exemplary transformation of data.

FIG. 6 is a block diagram illustrating exemplary data flow between the manufacturer, broker and one of the consumers of FIG. 1.

FIG. 7 is a flow chart of an exemplary method for generating a custom manual.

FIG. 8 is a block diagram illustrating an exemplary custom manual being generated.

FIG. 9 is another block diagram illustrating exemplary data flow between parties via a data broker.

FIGS. 10A-10B are flow charts of an exemplary method for registering a product with a manufacturer.

### DETAILED DESCRIPTION

Methods and systems are disclosed for providing consumer point of access to a vast array of customized product or service related data in an environment of manufacturers, service providers, distributors and consumers linked via a data broker. In some examples, a manufacturer purchases a set of information tags from the data broker. The manufacturer associates each information tag with an individual product and data concerning the individual product. The data concerning the individual product may include user manual information, service information or any other information concerning the individual product. The manufacturer may then deposit this associated data with the data broker or maintain it locally.

An information tag is provided to a consumer when the consumer purchases a product. The information tag may be provided physically via, for example, information embodied in a barcode, RFID chip or any other suitable information medium affixed to the product. The information tag may also be delivered electronically via, for example, telephone or email.

A distributor or service technician may augment the data concerning the individual product. As an example, a distributor may communicate the purchase date and purchase location to the data broker along with the information tag. The data broker then associates this purchase information with the individual product for access later by, for example, the consumer.

A consumer may access a website of the data broker to initiate the services of the data broker. The consumer may provide the data broker identification information along with the information tag associated with their product. The data broker uses the information tag as a key to navigate between the personal identification information of the consumer and the information concerning the individual product. As an example, a first-time user of the data broker may provide the data broker name and address information along with their information tag. The data broker stores the name, address and information tag information in a relational structure. The data broker then uses the information tag to retrieve and provide the information concerning the individual product to the consumer.

As an example, a purchaser of a toy train set may send their information tag and zip code to the data broker and receive a customized product/assembly manual in a text, audio and/or video format and a list of local hobby shops that may assist in assembling and operating the toy train set. As another example, a purchaser of wine may input their information tag at the data broker's web-site and receive a video tour of the vineyard at which the wine was made and a set of recipes that include the wine as an ingredient. As yet another example, a purchaser of a plane ticket may text message their information tag to the data broker and receive directions to the airport and surrounding hotels and restaurants.

The data broker or another authorized third party may serve the information concerning the individual product. The data broker, having received the information tag and identified the associated individual product and manufacturer, may then contact a third party authorized by the manufacturer to serve information to the consumer. As an example, the data broker may receive an information tag from a purchaser. The data broker determines that the information tag is associated with a particular video game console. The data broker contacts game makers affiliated with the manufacturer of the video game console. Commercials regarding games for the video game console are then served to the purchaser.

The data broker may also facilitate product registration. Stored consumer identification information along with the information tag may be provided to a manufacturer upon approval by the consumer.

In other examples, a service provider purchases a set of information tags from the data broker. The service provider associates each information tag with a service and data concerning the service. The data concerning the service may include an expiration date, usage restrictions or any other information concerning the service. The service provider may then deposit this associated data with the data broker or maintain it locally. As an example, an accounting house may issue an information tag via email to a consumer who has pre-purchased tax and other financial services from the accounting house. The consumer then submits the information tag to a data broker to determine, for example, their next scheduled financial planning session and the value of the unspent portion of their pre-purchased services from the accounting house. The accounting house may augment the information associated with the service with, for example, current tax rules relevant to the consumer and other information customized for the consumer.

Manufacturers and/or service providers may communicate with consumers via the data broker. As an example, a manufacturer may notify consumers having one of a set serial numbers of a product recall. The manufacturer identifies the information tags associated with the suspect serial numbers and communicates this information to the data broker along with the recall notice. The data broker then pushes this information onto the appropriate consumers. Coupons, customer satisfaction surveys or any other suitable information may similarly be provided.

Various products, such as cigarette and pop vending machines, may communicate their information tags and usage and performance summaries to the data broker for delivery to the respective owners/manufacturers of the products. As an example, a pop vending machine may be outfitted with a transceiver and a microprocessor. The microprocessor performs diagnostic tests on its mechanisms and tracks usage rates and current levels of stock within the vending machine. The vending machine periodically sends, via the transceiver, summaries of its diagnostics tests and usage and stock levels to the data broker. The data broker aggregates this information with other information from such vending machines and provides it to the owner/manufacturer of the vending machines. The data broker may facilitate the scheduling of service visits based on the diagnostic test information and communicate such scheduled visits to the owner/manufacturer.

A consumer may set the level of communication they are willing to accept from manufacturers, service providers and/or distributors. As an example, when initiating service with the data broker, a consumer may indicate that they are only willing to accept communications from a manufacturer regarding product recalls. As another example, a consumer may indicate that they are willing to accept any and all communications from a manufacturer and any third parties including coupons, customer surveys, commercials, advertisements, offers to participate in trial product tests, etc.

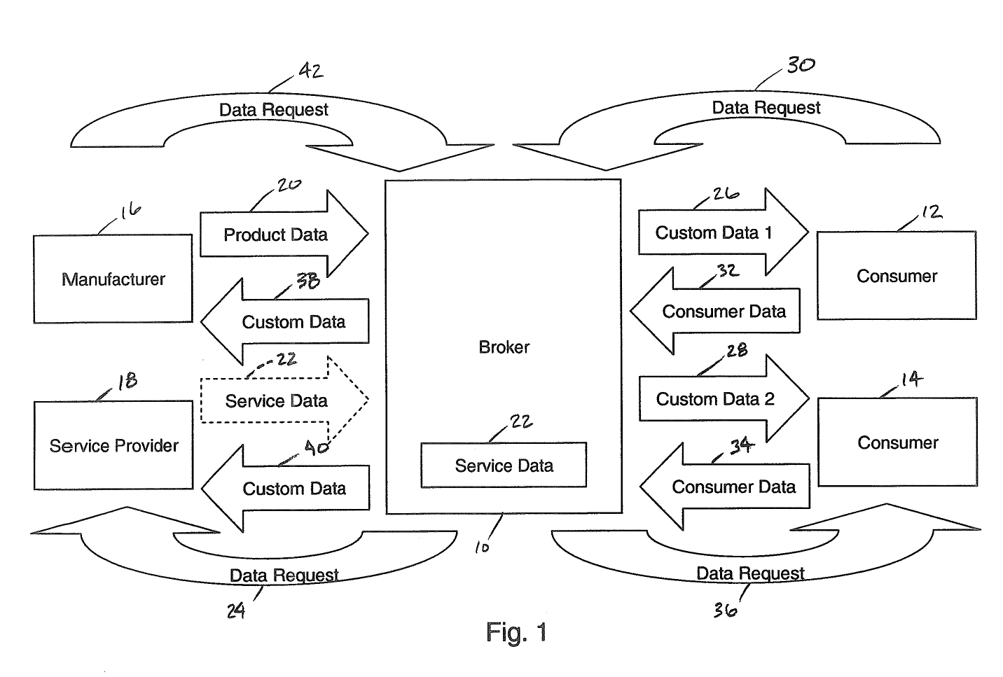

Referring to FIG. 1, a data broker 10 facilitates the electronic exchange of data between consumers 12, 14, a manufacturer 16 and a service provider 18. In other examples, a data broker may facilitate the electronic exchange of data between any number of consumers, manufacturers, service providers or other parties. The manufacturer 16 and service provider 18 provide product and service data 20, 22 respectively to the broker 10. The manufacturer provides the product data 20 to the broker 10 in response to one or more data requests 24. In the example of FIG. 1, the broker 10 does not store the product data 20 locally. The service provider 18 provides the service data 22 periodically to the broker 10. In the example of FIG. 1, the broker 10 stores the service data 22 locally. In other examples, the manufacturer 16 may provide the product data 20 periodically. Likewise, the service provider 18 may provide the service data 22 in response to a data request. Other scenarios are also possible. The broker 10 filters the product and service data 20, 22 and provides customized data 26, 28 to the consumers 12, 14 respectively in response to one or more data requests 30 from the consumers 12, 14.

The consumers 12, 14 may provide personal, or other types of consumer data, 32, 34 in response to one or more data requests 36 from the broker 10. As explained below, the broker 10 may use this consumer data 32, 34 to facilitate product or service registration by the consumers 12, 14 with the manufacture 16 and service provider 18. The broker 10 may also filter the consumer data 32, 34 and provide customized data 38, 40 to the manufacturer 16 and service provider 18 respectively in response to one or more data requests 42.

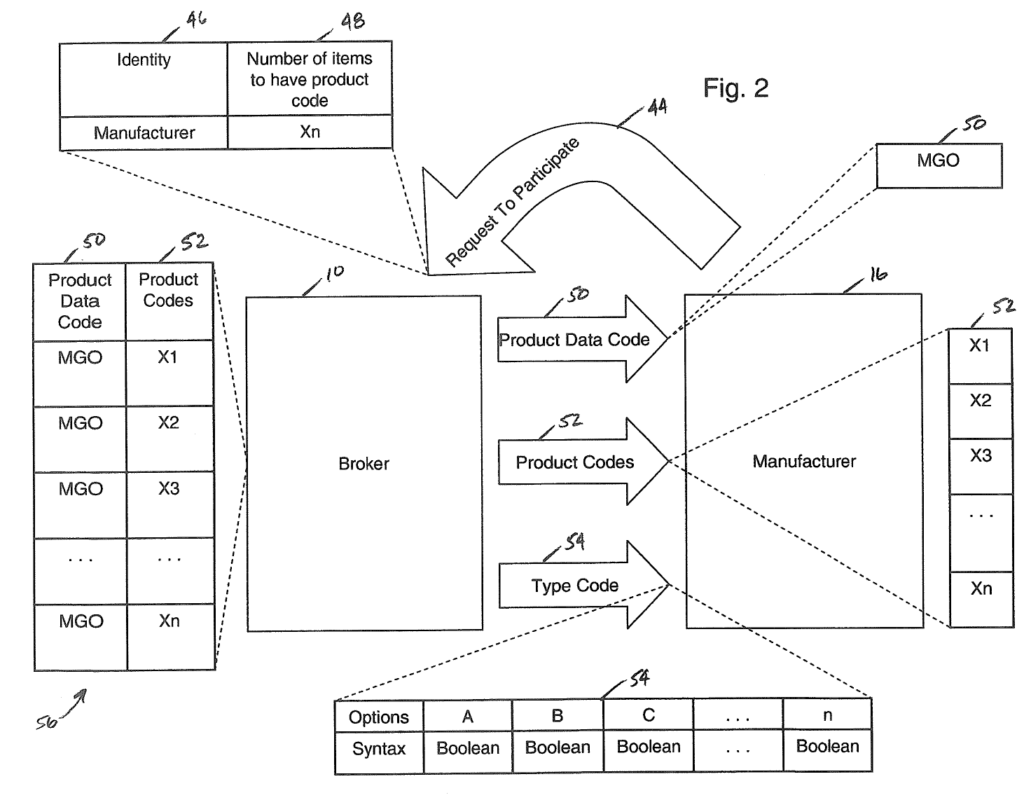

Referring to FIG. 2, the manufacturer 16 issues a request to participate 44 to the broker 10. The manufacturer 16 includes self-identifying information 46 and a number of product codes 48 it wishes to purchase from the broker 10. In response, the broker 10 issues a product data code 50 based on the self-identifying information 46, product codes 52 and a type code 54 to the manufacturer 16. Thus, there is a relationship between the self-identifying information 46 and the product data code 50. The product data code 50 will be used by the broker 10 to identify the manufacturer 16. The product data code 50 will also be used by the broker 10 and the manufacturer 16 to identify the product data 20 of the manufacturer 16. The product codes 52 will be used by the broker 10, consumers 12, 14 and manufacturer 16 to identify individual products manufactured by the manufacturer 16. The type code 54 will be used by the manufacturer 16 to ensure that any data concerning options associated with its products are in a standardized format that can be used by the broker 10. The type code 54 includes the syntax for such a standardized format. Each possible option associated with a product line will have its own field. These fields are represented as columns A-N in the example of FIG. 1. A boolean operator will indicate for an individual product whether that particular product has the option. As an example, if the boolean operator is true, the particular product has the option. If the boolean operator is false, the particular product does not have the option.

The broker 10 also has a relational data structure 56, such as a look-up table, that maps the product data code 50 for the manufacturer 16 with each of the product codes 52 provided to the manufacturer 16. The relational data structure 56 allows the broker 10 to identify the product data code 50, and thus the manufacturer 16, based on one of the product codes 52. The relational data structure 56 also allows the broker 10 to identify the product codes 52 associated with the product data code 50, and thus the manufacturer 16.

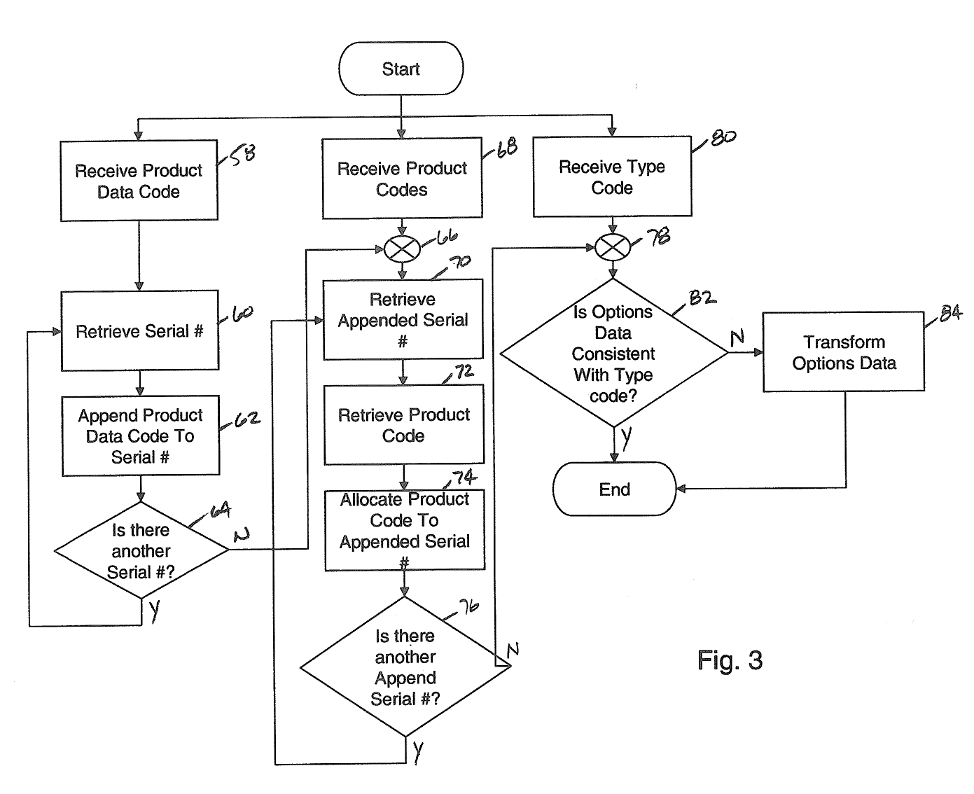

Referring to FIG. 3, a product data code is received at block 58. At block 60, a serial number associated with a particular product is retrieved. At block 62, the product data code is appended to the serial number. At diamond 64, it is determined whether there is another serial number associated with a particular product. If yes, the method returns to block 60. If no, the method proceeds to conditional element 66.

At block 68, product codes are received. At block 70, an appended serial number is retrieved. At block 72, one of the product codes is retrieved. At block 74, the product code is allocated to the appended serial number. At diamond 76, it is determined whether there is another appended serial number. If yes, the method returns to block 70. If no, the method proceeds to conditional element 78.

At block 80, a type code is received. At diamond 82, it is determined whether the options data associated with the products is consistent with the format dictated by the type code. If yes, the method ends. If no, the options data is transformed at block 84.

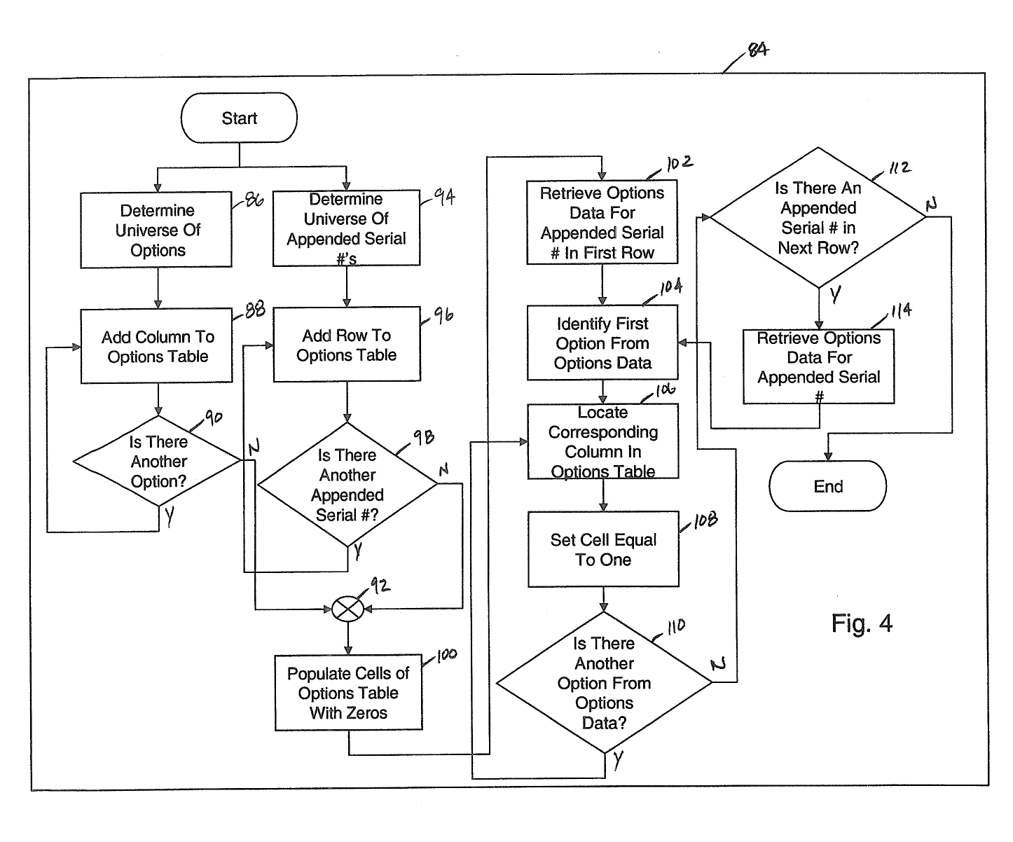

Referring to FIG. 4, a universe of options associated with the products is determined at block 86. At block 88, a column is added to a table for an option. At diamond 90, it is determined whether there is another option. If yes, the method returns to block 88. If no, the method proceeds to conditional element 92.

At block 94, a universe of appended serial numbers is determined at block 94. At block 96, a row is added to the table for an appended serial number. At diamond 98, it is determined whether there is another appended serial number. If yes, the method returns to block 96.

At block 100, the cells of the table are populated with zeroes. At block 102, options data associated with the product corresponding to the appended serial number in the first row of the table is retrieved. At block 104, the first option of the options data is identified. At block 106, the column in the table corresponding to the first option is located. At block 108, the cell at the intersection of the appended serial number in the first row of the table and the column corresponding to the first option is set equal to one. At diamond 110, it is determined whether there is another option, e.g., a second option, of the options data. If yes, the method returns to block 106. If no, it is determined whether there is an appended serial number in the next row of the table at diamond 112. If yes, options data associated with the appended serial number in the next row of the table is retrieved at block 114. The method then proceeds to block 104. If no, the method ends.

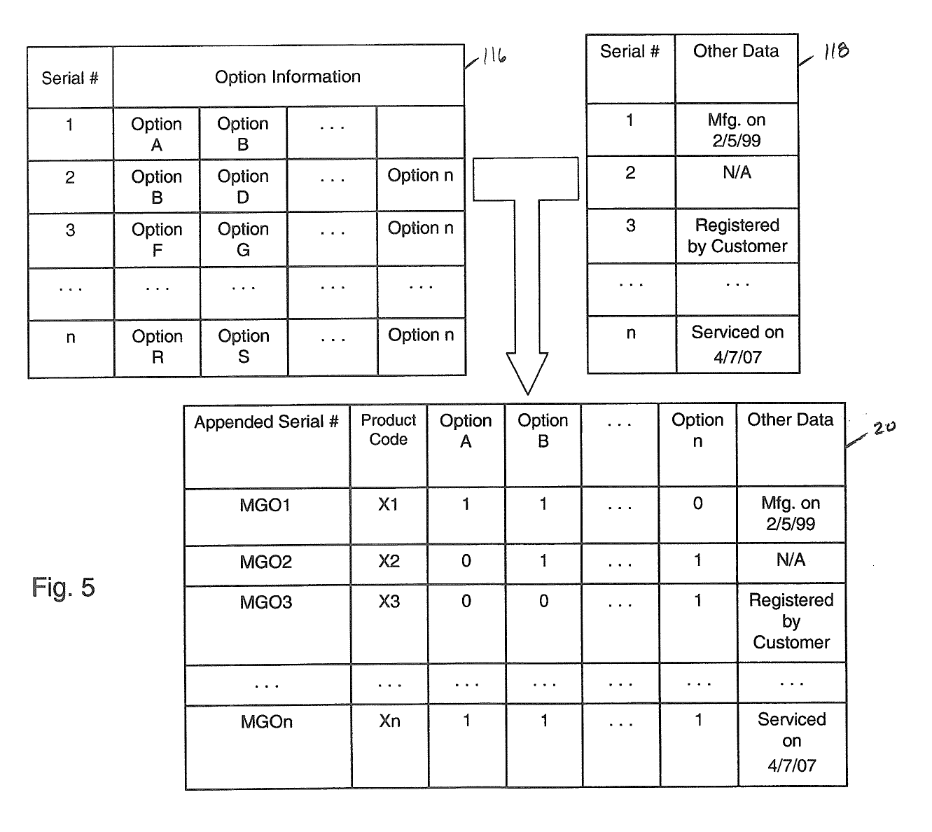

Referring to FIG. 5, data structures 116, 118 are transformed into the product data 20 provided to the broker 10 (FIG. 1) using the methods described with reference to FIGS. 3 and 4. The data structure 116 has a set of serial numbers for individual products mapped with options data for each individual product. As an example, a product having “1” for a serial number has options “A” and “B.” As another example, a product having “2” for a serial number has options “B,” “D” and “n.” The data structure 118 has the set of serial numbers for individual products mapped with other information for each individual product. As an example, the product having “1” for a serial number was manufactured on Feb. 5, 1999. As another example, the product having “2” for a serial number does not have any other information mapped with it.

Using the methods described with reference to FIGS. 3 and 4, each of the serial numbers has the product data code appended to it. As an example, the product having “1” for a serial number now has an appended serial number of “MGO1.” Each of the appended serial numbers has a unique product code allocated to it. As an example, the product having “MGO1” for an appended serial number has the product code “X1” allocated to it. Each of the appended serial numbers also has its corresponding options information expressed in a boolean format. As an example, the product having “MGO1” for an appended serial number has a “1” in the columns associated with options “A” and “B” and has a “0” in the rest of the columns. Additionally, each of the appended serial numbers has its corresponding other information mapped to it. As an example, the product having “MGO1” for an appended serial number has its manufactured on date information associated with it.

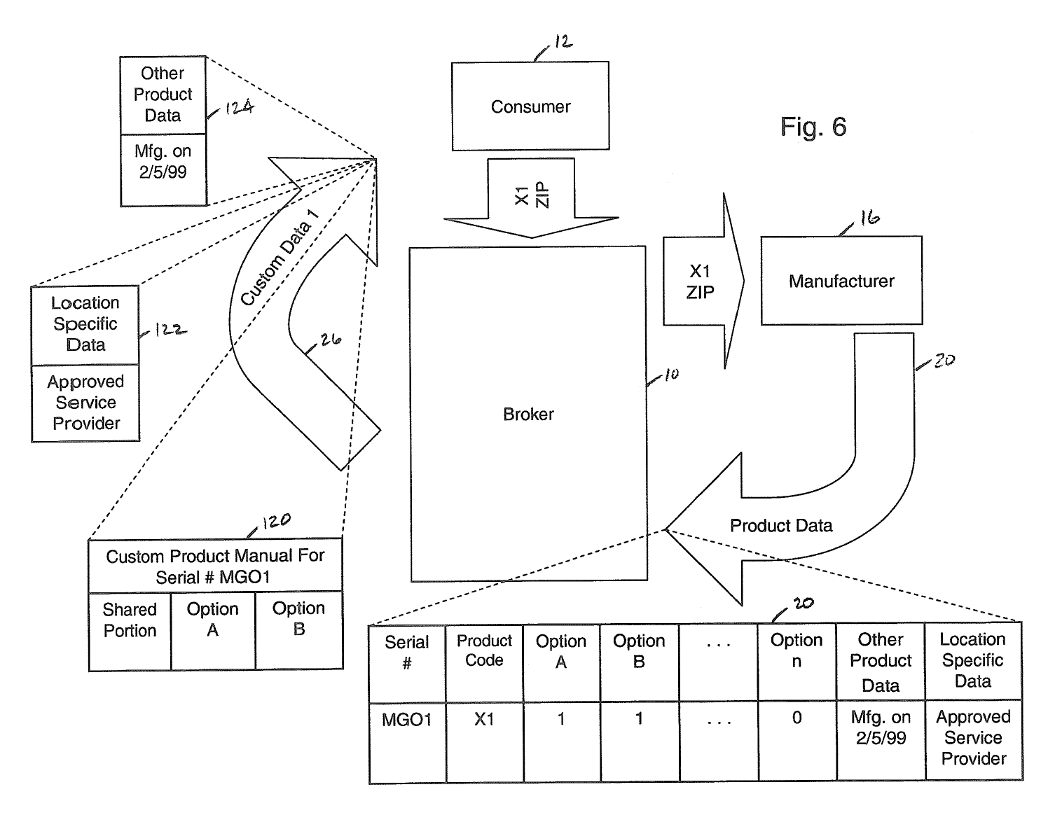

Referring to FIG. 6, the consumer 12, having received one of the product codes 52 by purchasing a product, provides this product code and his zip code to the broker 10. In the example of FIG. 6, the consumer 12 accesses a web-site hosted by the broker 10 and enters the product code and zip code into a data field. In other examples, the consumer 12 may text message the product code and zip code to the broker 10. Other techniques to provide the product code and zip code to the broker 10 may also be used. In still other examples, the consumer 12 may only provide the product code to the broker 10.

The broker 10 accesses the relational data structure 56 (FIG. 2) and compares the product codes of the relational data structure 56 to the received product code to identify the manufacturer 16. The broker 10 electronically sends the received product code and zip code to the manufacturer 16. This implicit request for data from the broker 10 to the manufacturer 16 via the product code preserves the anonymity of the consumer 12.

The manufacturer 16 identifies the product data 20 based on the received product code. The manufacturer electronically sends the product data 20 associated with the received product code to the broker 10. In the example of FIG. 6, the product data 20 includes location specific data. This location specific data is based on the zip code received by the manufacturer 16. In this example, the location specific data includes an approved local service provider for the product associated with the product code. The location specific data, however, may include any suitable information or promotional materials.

The broker 10 electronically provides a customized product manual 120 which includes information regarding options, i.e., “Option A” and “Option B,” specific to the product having the serial number “MGO1,” i.e., the product associated with the product code “X1,” via the web-site. The broker 10 also provides the location specific data 122, and other product data 124 to the consumer 12 via the web-site.

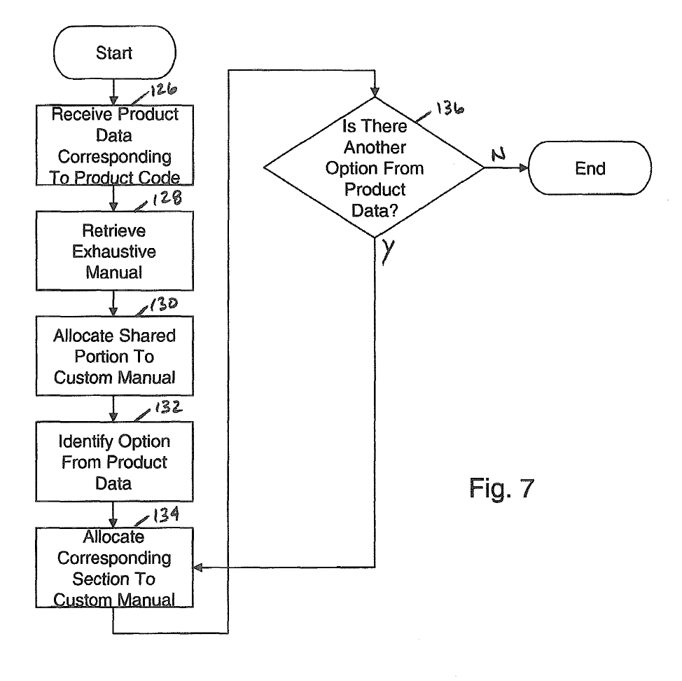

Referring to FIG. 7, product data corresponding to a product code is received at block 126. At block 128, an exhaustive user's manual is retrieved. An exhaustive user's manual, in the example of FIG. 7, is a user's manual for a particular line of products that includes information for all configurations of the products of the product line. For example, a product line may have several features that are common to all product configurations and several features that are optional to all the product configurations. The common features are described in a portion of the exhaustive user's manual that is shared by all the products. Each optional feature of the exhaustive user's manual is described in its own discrete section and may be selectively included, as described below, in custom product manuals generated for particular products.

At block 130, a shared portion of the exhaustive product manual is allocated to a custom product manual. At block 132, an option from the product data is identified. At block 134, a portion of the exhaustive user's manual corresponding to the identified option is allocated to the custom product manual. At diamond 136, it is determined whether there is another option from the product data. If yes, the method returns to block 134. If no, the method ends.

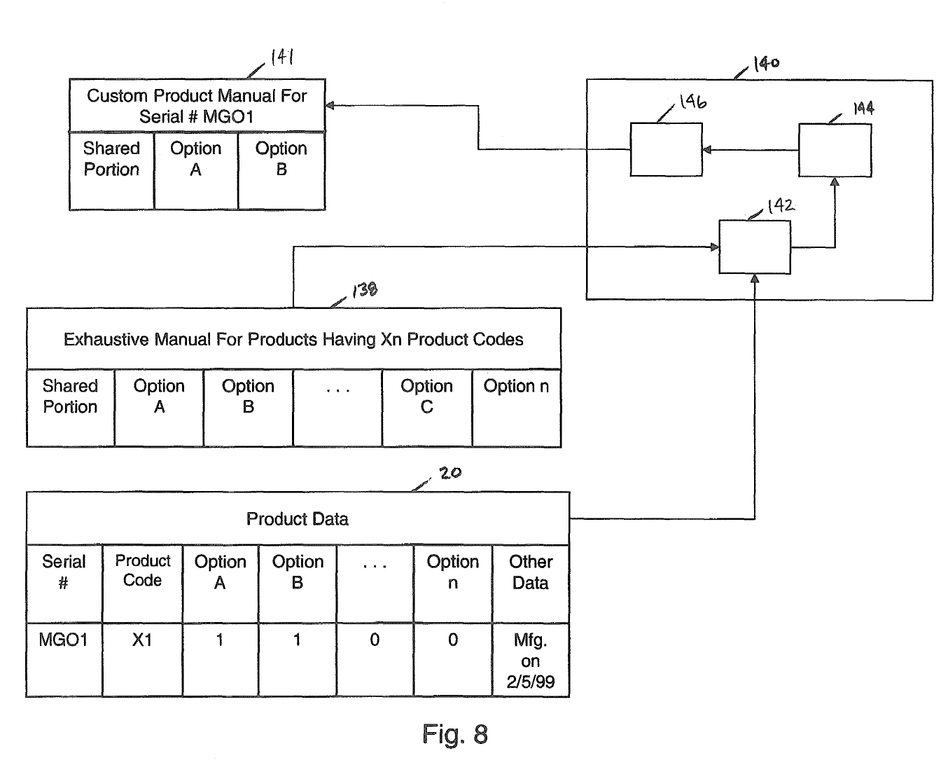

Referring to FIG. 8, the product data 20 is received by the broker 10. The broker 10 accesses an exhaustive user's manual 138 stored in a memory local to the broker 10. In other examples, the broker 10 may receive the exhaustive user's manual 138 in response to the implicit request for data described with reference to FIG. 6. In still other examples, the broker 10 may periodically receive the exhaustive user's manual 138 from the manufacturer 16.

Using the method described with reference to FIG. 7, a computing system 140 associated with the broker 10 generates a custom user's manual 141 from the product data 20 and the exhaustive user's manual 138. In the example of FIG. 8, a user's manual module 142 of the computing system 140 reads in the product data 20 associated with the product having the serial number “MGO1” and product code “X1.” The user's manual module 142 also reads in the exhaustive user's manual 138. As described above, the exhaustive user's manual 138 includes a shared portion which contains information applicable to common features of all product configurations including the product having the serial number “MGO1.” The exhaustive user's manual 138 also includes segments which contain information applicable to optional features of all the product configurations. That is, the exhaustive user's manual 138 includes segments of information applicable to “Option A” through “Option n.” Each of these segments may be selectively included in the custom user's manual 141 to tailor the custom user's manual 141 to the product having the serial number “MGO1.” In the example of FIG. 8, the product data 20 indicates, via boolean operators, that the product having the serial number “MGO1” and the product code “X1” includes “Option A” and “Option B” but does not include any other options. A generating engine 144 of the computing system 140, executing steps 130-136 of FIG. 7, allocates the shared portion of the exhaustive user's manual 138 and the segments applicable to “Option A” and “Option B” to generate the custom user's manual 141. An interface 146 of the computing system 140 outputs the custom user's manual 141.

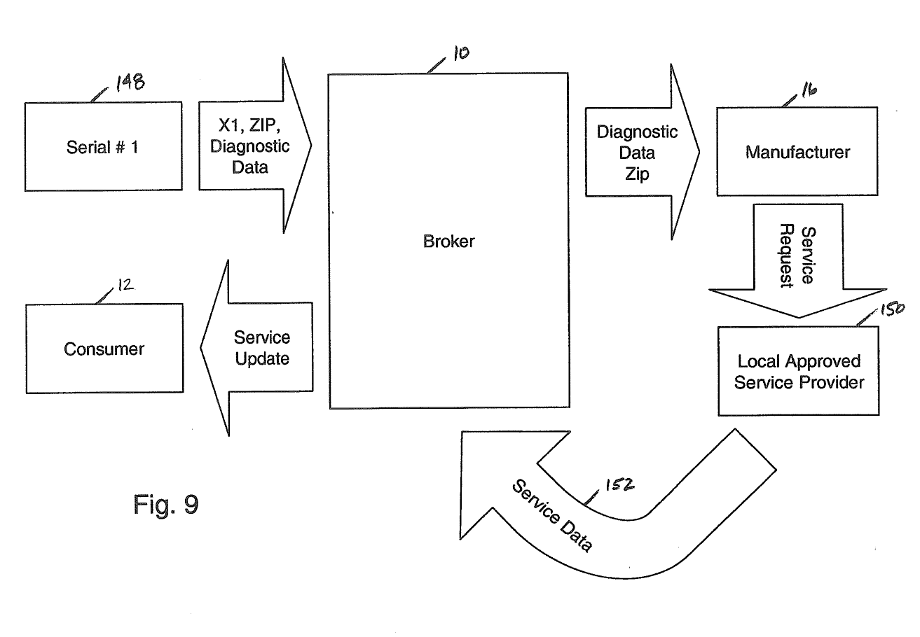

Referring to FIG. 9, a product, such as a vending machine 148, automatically provides its product code, zip code of its current location and self-diagnostic data to the broker 10. The vending machine 148 includes computing capabilities suitably connected with an electronic communication network accessible by the broker 10, such as the internet, that permit it to automatically provide such data. The product code and zip code information may be loaded to the vending machine 148 manually by an operator. In other examples, the product may be a household appliance or any other suitable product.

Using techniques described herein, the broker 10 uses the product code to identify the manufacturer 16. The broker 10 electronically sends the diagnostic data and zip code to the manufacturer 16.

Using techniques described herein, the manufacturer 16 identifies the serial number of the vending machine 148 based on the product code. The manufacturer 16 also determines an approved service technician 150 local to the vending machine 148 based on the zip code and diagnostic data. The manufacturer 16 notifies the approved service technician 150 of the condition of the vending machine 148 and prompts the service technician 150 to provide service data 152 to the broker 10 appropriate to the diagnostic data. The broker 10 sends a service update to the consumer 12, who in this example owns and operates the vending machine 148, regarding the status of the vending machine 148 and the contact information for the service technician 150.

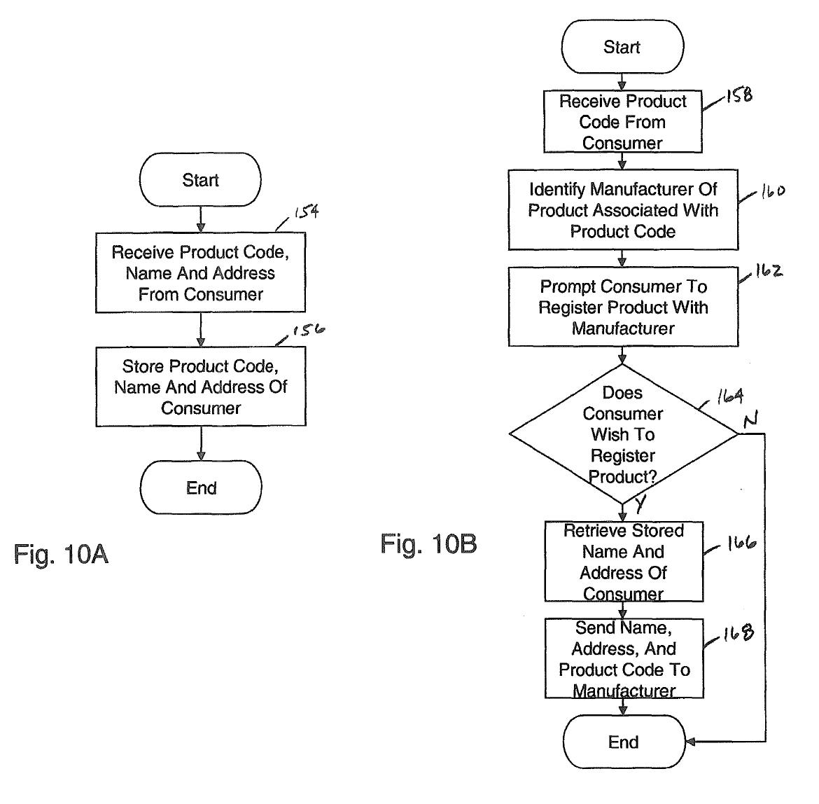

Referring to FIG. 10A, a product code, name and address of a consumer is received at block 154. At block 156, the product code, name and address of the consumer is stored.

Referring to FIG. 10B, a product code is received from the consumer of FIG. 10A at block 158. At block 160, a manufacturer of the product associated with the product code is identified. At block 162, the consumer is prompted to register their product with the manufacturer. At diamond 164, it is determined whether the consumer wishes to register their product. If no, the strategy ends. If yes, the name and address of the consumer stored as described with reference to FIG. 10A is retrieved at block 166. At block 168, the received product code and the retrieved name and address of the consumer is electronically sent to the manufacturer.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed:

1. A method for providing information for an instance of a product or service via an information broker, the method comprising:
receiving identity information for a plurality of providers of products or services;
generating, for each provider, a set of identifiers for instances of the products or services;
mapping each set of the generated identifiers with the identity information for a respective one of the plurality of provides;
receiving an identifier associated with an instance of a product or service;
determining whether the received identifier matches any of the generated identifiers;
identifying one of the plurality of providers via the mapping if the received identifier matches any of the generated identifiers;
sending the received identifier to the one provider;
receiving a first set of information identifying attributes of the instance of the product or service mapped with the received identifier in response to sending the received identifier to the one provider wherein the first set of information is in a format specified by the data broker;
compiling a second set of information identifying attributes of the instance of the product or service based on the first set of information; and
providing the second set of information.

2. The method of claim 1 wherein the first set of information includes a boolean expression indicative of optional features of the instance of the product or service.

3. The method of claim 2 wherein compiling a second set of information identifying attributes of the instance of the product or service based on the first set of information includes generating a custom user manual for the instance of the product or service based on the boolean expression indicative of the optional features of the instance of the product or service.

4. The method of claim 2 wherein the boolean expression indicative of the optional features of the instance of the product or service includes a boolean operator associated with each of the optional features and wherein each boolean operator has a true state indicative of the presence of an optional feature in the instance of the product or service or a false state indicative of the absence of the optional feature in the instance of the product or service.

5. The method of claim 1 further comprising receiving an additional identifier associated with an additional instance of a product and diagnostic data for the additional instance of the product;
analyzing the diagnostic data; and
scheduling a service visit for the additional instance of the product based on the analysis.

6. The method of claim 1 further comprising receiving an additional identifier from an additional product and a set of data identifying attributes of the additional product; and
providing the set of data to one of the plurality of providers.

7. The method of claim 1 wherein the second set of information includes at least one of a customized user manual for the instance of the product or service, a list of local service providers and a date of manufacture.

8. The method of claim 1 further comprising receiving location information associated with the instance of the product or service wherein the second set of information is further based on the location information.

9. A method for providing information for an instance of a product or service via an information broker, the method comprising:
generating, for each of a plurality of providers of products or services, a respective set of identifiers for instances of products or services;
sending a respective one of the sets of generated identifiers to each of the plurality of providers;
receiving a mapping from one or more of the plurality of providers wherein each mapping includes at least some of the generated identifiers each associated with a set of information identifying attributes of an instance of a product or service and wherein the sets of information are in a format specified by the information broker;
receiving a request for information about an instance of a product or service including an identifier associated with the instance of the product or service;
determining whether the received identifier matches any of the generated identifiers;
retrieving the set of information identifying attributes of the instance of the product or service requested via the mappings if the received identifier matches any of the generated identifiers;
compiling an additional set of information identifying attributes of the instance of the product or service requested based on the retrieved set of information; and
providing the additional set of information.

10. The method of claim 9 wherein the retrieved set of information includes a boolean expression indicative of optional features of the instance of the product or service.

11. The method of claim 10 wherein compiling an additional set of information identifying attributes of the instance of the product or service requested based on the retrieved set of information includes generating a custom user manual for the instance of the product or service based on the boolean expression indicative of the optional features of the instance of the product or service.

12. The method of claim 10 wherein the boolean expression indicative of the optional features of the instance of the product or service includes a boolean operator associated with each of the optional features and wherein each boolean operator has a true state indicative of the presence of an optional feature in the instance of the product or service or a false state indicative of the absence of the optional feature in the instance of the product or service.

13. The method of claim 9 further comprising receiving another identifier associated with another instance of a product and diagnostic data for the another instance of the product;
analyzing the diagnostic data; and
scheduling a service visit for the another instance of the product based on the analysis.

14. The method of claim 9 further comprising receiving another identifier from another product and a set of data identifying attributes of the another product; and
providing the set of data to one of the plurality of providers.

15. The method of claim 9 wherein the additional set of information includes at least one of a customized user manual for the instance of the product or service requested, a list of local service providers and a date of manufacture.

16. The method of claim 9 further comprising receiving location information associated with the instance of the product or service requested wherein the additional set of information is further based on the location information.

17. A computer system for generating a custom product manual, the system comprising:
a product manual module configured to receive optional product manual segments corresponding to optional product features and data indicative of optional product features of an instance of a product;
a generating module configured to automatically generate a custom product manual based on the data indicative of the optional product features of the instance of the product; and
an interface module configured to output the custom product manual having at least one optional product manual segment corresponding to at least one optional product feature of the instance of the product.

18. The system of claim 17 wherein the product manual module is further configured to receive mandatory product manual segments corresponding to mandatory product features and wherein the interface module is further configured to output the custom product manual having at least one mandatory product manual segment.

19. The system of claim 17 wherein the data indicative of the optional product features of the instance of the product comprises a boolean expression including a boolean operator associated with each of the optional product features.

20. The system of claim 19 wherein each boolean operator has a true state indicative of the presence of an optional product feature in the instance of the product or a false state indicative of the absence of the optional product feature in the instance of the product.

21. The system of claim 20 wherein automatically generating the custom product manual based on the data indicative of the optional product features of the instance of the product includes retrieving the optional product manual segments corresponding to the optional product features having true state boolean operators.

22. A method for registering a product having a product code with the product manufacturer, the method comprising:
receiving customer information identifying a customer;
receiving the product code from the customer;
mapping the product code with the customer information;
identifying the manufacturer of the product based on the product code;
prompting the customer to register the product with the manufacturer in response to receiving the product code from the customer;
receiving a response to the prompt;
retrieving the customer information based on the product code; and
sending the customer information to the manufacturer, thereby registering, for the customer, a product having a product code with the product manufacturer.
